(19) United States
(12) Patent Application Publication
(10) Pub. No.: US 2015/0070222 A1
(43) Pub. Date: Mar. 12, 2015

(54) SIGNAL TRANSFER APPARATUS HAVING ANTENNA UNIT

(71) Applicant: SAMSUNG ELECTRONICS CO., LTD., Suwon-si (KR)

(72) Inventors: Jun-seok KANG, Bucheon-si (KR); Hyun-koo KANG, Yongin-si (KR); Scott Seongwook LEE, Suwon-si (KR)

(73) Assignee: Samsung Electronics Ltd, Suwon (KR)

(21) Appl. No.: 14/454,033

(22) Filed: Aug. 7, 2014

(30) Foreign Application Priority Data
Sep. 9, 2013 (KR) 10-2013-0107991

(51) Int. Cl. H01Q 1/24; H01Q 1/52; H01Q 13/10

(52) U.S. Cl. CPC H01Q 1/24; H01Q 13/10; H01Q 1/526
USPC 343/702

(57) ABSTRACT

A signal transfer apparatus including an antenna unit is provided. A signal transfer apparatus includes a housing, an interface provided at a housing to be connected to an external device to transmit a signal to or receive a signal from the external device, an external case configured to cover the housing, an antenna unit configured to be a slot antenna, and a communication module which is connected to the slot antenna and transmits a signal to or receives a signal from an external wireless device through the slot antenna, a controller provided in the housing to be electrically connected to the interface and the antenna unit, and transmit an external signal received through the interface or the antenna unit directly to a display apparatus or convert the external signal and transmit the converted signal to the display apparatus.

### CROSS-REFERENCE TO RELATED APPLICATIONS

This application claims priority from Korean Patent Application No. 10-2013-0107991, filed on Sep. 9, 2013, in the Korean Intellectual Property Office, the disclosure of which is incorporated herein by reference in its entirety.

### BACKGROUND

1. Field

Apparatuses and methods consistent with the embodiments relate to a signal transfer apparatus and, more particularly, to a signal transfer apparatus having an antenna unit which includes a slot antenna and a communication module.

2. Description of the Related Art

In general, a signal transfer apparatus, such as a jack pack apparatus and a set-top box apparatus, transfers an external signal, such as an image signal, a video signal, and an audio signal, which is received from diverse kinds of electronic devices to a television (TV).

A jack pack apparatus is an apparatus which is separate from a TV and is connected to the TV via one connect cable in order to prevent a plurality of cables connected to diverse devices from being directly connected to the TV so that disorder caused by the plurality of cables may be minimized. The jack pack apparatus includes a connecting terminal, such as a digital visual interface (DVI), a high-definition multimedia interface (HDMI), an audio/video (AV) interface, and a Sony/Philips digital interconnect format (S/PDIF) interface, that connects the jack pack apparatus to a communication module or diverse kinds of devices so that diverse kinds of signals input from diverse kinds of external devices may be transferred to the TV (for example, an ultra high definition (UHD) TV) via the one connect cable. The separate jack pack apparatus may include a built-in TV tuner.

A set-top box apparatus is an apparatus that restores a compressed signal transmitted from a video server via a digital network into an original video or audio signal, and transfers the restored signal to a TV. The set-top box may convert an analog broadcast into a digital broadcast and, in particular, have a function for enabling the internet through an internet protocol TV (IPTV) recently.

In the related art, such a signal transfer apparatus includes an antenna to transmit a wireless signal to or receive a wireless signal from an external wireless device. The antenna may be directly patterned on a printed circuit board included in the signal transfer apparatus. Alternatively, an antenna, such as a planar inverted-F antenna (PIFA), may be connected to a connector via an radio frequency (RF) cable and may be connected to a wireless communication module mounted in a printed circuit board.

The antenna patterned on the printed circuit board may be simply manufactured. However, since an external case is made of a metallic material and thus the antenna is in a closed environment, a radiation pattern may deteriorate, and antenna characteristics may not be better than that of general antennas (a separate antenna that is connected to the exterior of the signal transfer apparatus).

However, in the case of the PIFA, the performance of the PIFA is a little bit better than that of the antenna patterned on the printed circuit board, but, an assembly defect rate between the connector and the RF cable, and a high unit cost of the RF cable raises manufacturing costs of the signal transfer apparatus. Also, since an external case is made of a metallic material, there is a limit to sufficiently securing a radiation pattern of the antenna, thereby deteriorating the performance of the antenna.

### SUMMARY

Additional aspects and/or advantages will be set forth in part in the description which follows and, in part, will be apparent from the description, or may be learned by practice of the embodiments.

Exemplary embodiments overcome the above disadvantages and other disadvantages not described above. Also, the embodiments are not required to overcome the disadvantages described above, and an exemplary embodiment may not overcome any of the problems described above.

The embodiments provide a signal transfer apparatus including a slot antenna on an external case or a shield plate in order to enhance the performance to transmit or receive an antenna signal.

According to an aspect of the embodiments, a signal transfer apparatus includes a housing, an interface provided at a housing to be connected to an external device to transmit a signal to or receive a signal from the external device, an external case configured to cover the housing, an antenna unit configured to comprise a slot antenna, and a communication module which is connected to the slot antenna and transmits a signal to or receives a signal from an external wireless device through the slot antenna, a controller provided in the housing to be electrically connected to the interface and the antenna unit, and transmit an external signal received through the interface or the antenna unit directly to a display apparatus or convert the external signal and transmit the converted signal to the display apparatus.

The external case may be made of a conductive metallic material, and the slot antenna is formed on the external case. In this case, the slot antenna may include at least one radiation pattern which is perforated on the external case. In this case, a connecting terminal of the communication module may be connected to a connecting terminal of the slot antenna via at least one cable, or may be directly soldered to a connecting terminal of the slot antenna.

The signal transfer apparatus may further include a shield plate configured to be made of a conductive metallic material to block an electromagnetic wave and be covered by the external case. The eternal case may be made of a non-metallic material. The slot antenna may include at least one radiation pattern perforated on the shield plate. In this case, a connecting terminal of the communication module may be connected to a connecting terminal of the slot antenna via at least one cable, or may be directly soldered to a connecting terminal of the slot antenna.

The shield plate may include an antenna signal radiation hole through which an antenna signal of the slot antenna passes, and the antenna unit may be provided at a location corresponding to the antenna signal radiation hole.

The antenna unit may include a conductive metal plate on which at least one radiation pattern of the slot antenna is perforated. In this case, the signal transfer apparatus may further include a coupling configured to separably couple the metal plate to the shield plate. A connecting terminal of the communication module may be directly soldered to a connecting terminal of the slot antenna.

The coupling may be a pair of slots extended in parallel along sides of the antenna signal radiation hole which face each other.

The coupling may be a conductive adhesive tape to attach the metal plate to the shield plate.

The coupling may be a plurality of connecting members to fix the metal plate to the shield plate.

The coupling may be a plurality of fixing protrusion which are extended from the shield plate and are formed around the antenna signal radiation hole.

The metal plate may be attached with at least one foreign substance blocking member to prevent a foreign substance from flowing into the radiation pattern. In this case, the foreign substance blocking member is an insulating tape or an insulating film.

The communication module may include a first communication circuit and a second communication circuit to transmit or receive at least two different signals respectively, and the slot antenna may include at least one first radiation pattern to be connected to the first communication circuit, and at least one second radiation pattern to be connected to the second communication circuit.

Additional and/or other aspects and advantages of the embodiments will be set forth in part in the description which follows and, in part, will be obvious from the description, or may be learned by practice of the embodiments.

According to an aspect of the embodiments a signal transfer apparatus includes an interface provided to be connected to an external device, a case, a slot antenna formed by the case and a controller connected to the interface and the antenna unit to transfer a signal between the interface and the antenna where the case may be metal and the antenna may be formed by perforation of the metal case.

### BRIEF DESCRIPTION OF THE DRAWINGS

The above and/or other aspects of the embodiments will be more apparent by describing certain exemplary embodiments with reference to the accompanying drawings, in which:

FIG. 1 is a perspective view of a signal transfer apparatus consistent with a first exemplary embodiment;

FIG. 2 illustrates the interior of an external case to show a connection state between a slot antenna and a communication module shown in FIG. 1;

FIG. 3 is a perspective view of an example of the communication module that is directly soldered to a conductive member of the slot antenna;

FIG. 4 is a perspective view of another connection structure between the slot antenna and the communication module shown in FIG. 3;

FIGS. 5 and 6 illustrate diverse patterns of the slot antenna;

FIG. 7 is a perspective view of a signal transfer apparatus consistent with a second exemplary embodiment;

FIG. 8 is an exploded perspective view of an example in which a slot antenna of the signal transfer apparatus consistent with the second exemplary embodiment is slotted into a shield plate;

FIG. 9 illustrates an example in which the slot antenna of the signal transfer apparatus consistent with the second exemplary embodiment is taped on the shield plate;

FIG. 10 illustrates an example in which the slot antenna of the signal transfer apparatus consistent with the second exemplary embodiment is fixed on the shield plate by a plurality of connecting members;

FIG. 11 illustrates an example in which the slot antenna of the signal transfer apparatus consistent with the second exemplary embodiment is fixed on the shield plate by a plurality of fixing protrusions;

FIG. 12 is a perspective view of an example in which foreign substance blocking members are attached to both sides of the slot antenna to prevent foreign substances from flowing into a radiation pattern of the slot antenna perforated on a metal plate; and

FIG. 13 is a perspective view of a signal transfer apparatus consistent with a third exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the embodiments by referring to the figures.

In the following description, same drawing reference numerals are used for the same elements even in different drawings. The matters defined in the description, such as detailed construction and elements, are provided to assist in a comprehensive understanding of the embodiments. Thus, it is apparent that the exemplary embodiments can be carried out without those specifically defined matters. Also, well-known functions or constructions are not described in detail since they would obscure the embodiments with unnecessary detail.

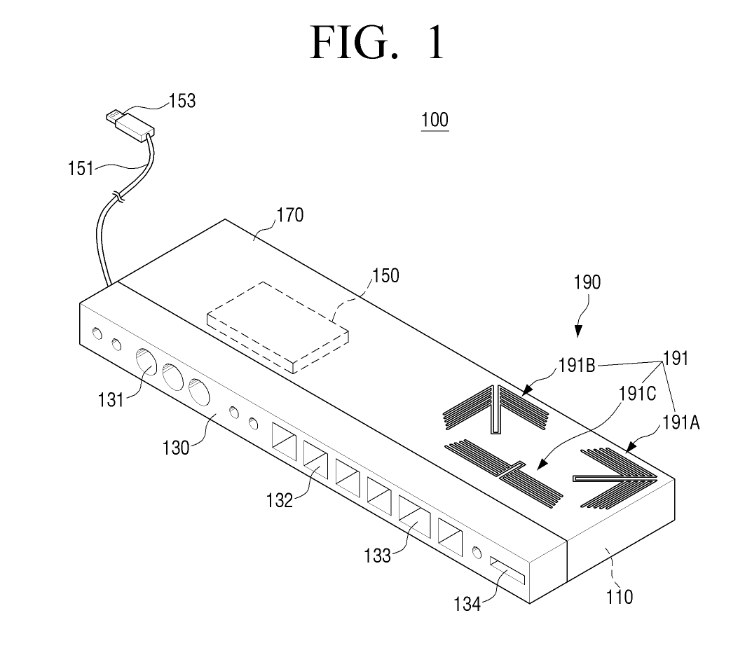

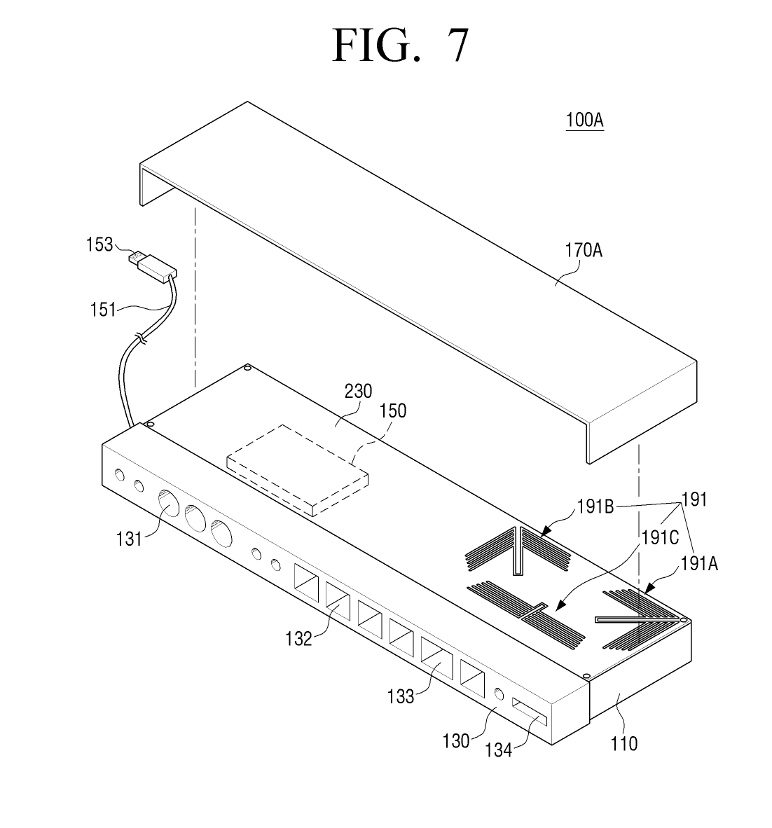

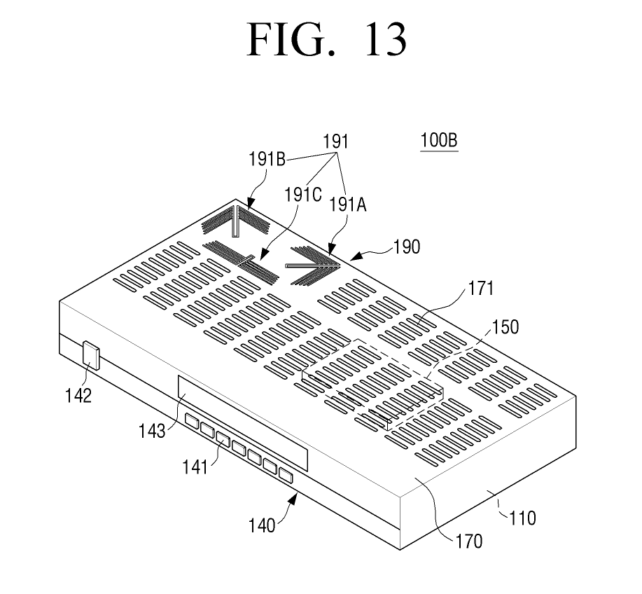

Signal transfer apparatuses 100 (FIG. 1) and 100A (FIG. 7) consistent with first and second exemplary embodiments are jack pack apparatuses, and a signal transfer apparatus 1008 (FIG. 13) consistent with a third exemplary embodiment is a set-top box apparatus. The jack pack apparatus and the set-top box apparatus have an antenna unit including a slot antenna in common.

With reference to FIGS. 1 to 3, the signal transfer apparatus 100 consistent with the first exemplary embodiment may includes a housing 110, a connecting terminal panel 130, a controller 150, an external case 170, and an antenna unit 190.

The housing 110 is made of a metallic material to maintain a predetermined rigidity or a synthetic resin material having a predetermined hardness.

The connecting terminal panel 130 is an interface that is connected to diverse external devices in order to transmit a signal to or receive a signal from the diverse external devices. The connecting terminal panel 130 may include a plurality of connecting terminals 131, 132, 133, and 134. The connecting terminals 131, 132, 133, and 134 may include a digital visual interface (DVI), a high-definition multimedia interface (HDMI), an audio/video (AV) interface, a Sony/Philips digital interconnect format (S/PDIF) interface, and the like.

The controller 150 is provided in the housing 10, and processes a signal input from diverse external devices through the connecting terminal panel 130 or processes a signal input through the antenna unit 190. In addition, the controller 150 transmits diverse types of signals to a TV (not shown, for example, an ultra high definition (UHD) TV) through one for a single connection connecting cable 151. In this case, the at least one connect cable 151 may include a connecting terminal 153 that is electrically connected to a connecting terminal (not shown) of the TV.

The external case 170 may be made of a metallic material in order to block electromagnetic interference (EMI) radiated from the controller 150 and diverse electronic units (not shown) in the housing 110 and to enhance electromagnetic compatibility (EMC). In this case, the external case 170 may be a conductive material to be formed with a slot antenna 191 of the antenna unit 190 in one body so as to transmit or receive a signal.

The antenna unit 190 may include the slot antenna 191, and a communication module 193 which is electrically connected to the slot antenna 191.

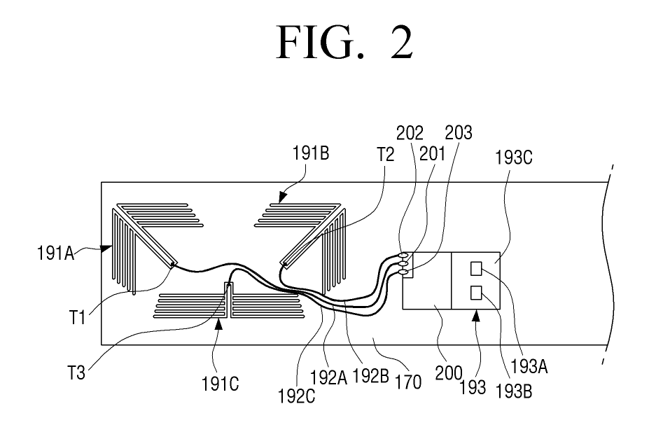

The slot antenna 191 may include first radiation patterns 191A and 191B and a second radiation pattern 191C which are perforated on the external case 170 that is a conductive material. In this case, the location of the first and second radiation patterns 191A, 191B, and 191C are not limited to that shown in FIGS. 1 and 2. The first and second radiation patterns 191A, 191B, and 191C may be provided on an appropriate location of the external case 170 in light of the controller 150 and adjacent electronic unit (not shown).

The first radiation patterns 191A and 191B are substantially symmetrical to each other, and radiate a first antenna signal (for example, a Wi-Fi signal). The second radiation pattern 191C is provided below the first radiation patterns 191A and 191B, and radiates a second antenna signal (for example, a Bluetooth signal) which is different from the first antenna signal.

The first radiation patterns 191A and 191B and the second radiation pattern 191C are connected to the communication module 193 via first to third cables (for example, RF cables) 192A, 192B, and 192C respectively. In this case, one ends of the first and second cables 192A and 192B are connected to connecting terminals T1 and T2 of the first radiation patterns 191A and 191B, and the other ends are connected to first and second connecting terminals 201 and 202 of a connector 200. In addition, one end of the third cable 192C is connected to a connecting terminal T3 of the second radiation pattern 192C, and the other end is connected to a third connecting terminal 203 of the connector 200.

In this case, the connector 200 is electrically connected to one side of the communication module 193 which is connected to the controller 150.

The communication module 193 may include a first communication circuit 193A to transmit a signal to or receive a signal from an external wireless device through the first radiation patterns 191A and 191B, and a second communication circuit 193B to transmit a signal to or receive a signal from an external wireless device through the second radiation pattern 191C. In this case, an external wireless device that transmits a signal to or receives a signal from the first and second communication circuits 193A and 193B may include a separate controller, a smart phone, a table PC, etc. The first and second communication circuits 193A and 193B are mounted in a printed circuit board (PCB) 193C.

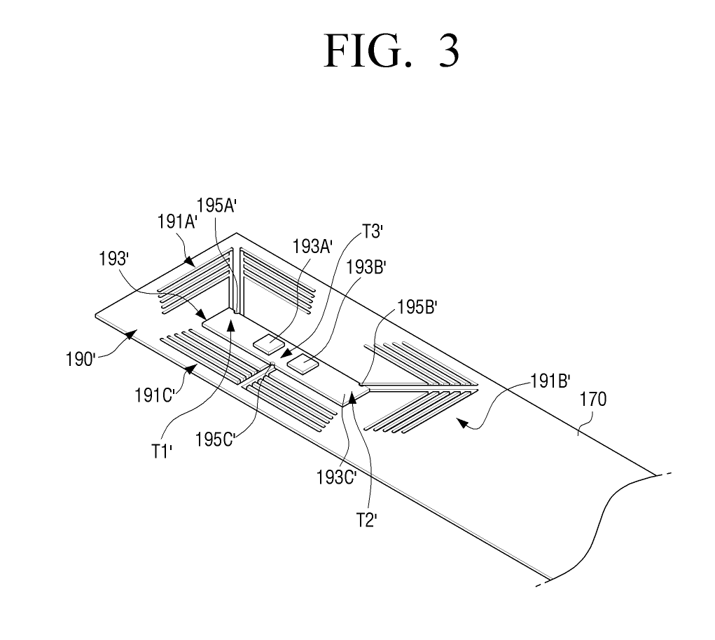

In the aforementioned antenna unit 190, the slot antenna 191 and the communication module 193 are separate from each other, and are connected to each other via the plurality of cables 192A, 192B, and 192C. However, the antenna unit 190 is not limited to the separate type, and may include the slot antenna 191 and the communication module 193 in or as one body as shown in FIG. 3.

With reference to FIG. 3, an antenna unit 190′ may not include the plurality of cables 192A, 192B, and 192C unlike the aforementioned antenna unit 190, thereby reducing the manufacturing costs. In the antenna unit 190′, a plurality of connecting terminals 195A′, 195B′, and 195C′ of a communication module 193′ are directly soldered to connecting terminals T1′, T2′, and T3′ of first and second radiation patterns 191A′, 191B′, and 191C′ respectively.

In this case, the plurality of connecting terminals 195A′, 195B′, and 195C′ of the communication module 193′ are formed in a semicircle shape at ends of a PCB 193C′ which is adjacent to the connecting terminals T1′, T2′, and T3′ of the first and second radiation patterns 191A′, 191B′, and 191C′. The inside of the plurality of connecting terminals 195A′, 195B′, and 195C′ is coated with a conductive material. In addition, the plurality of connecting terminals 195A′, 195B′, and 195C′ are electrically connected to first and second communication circuits 193A′ and 193B′ by wiring.

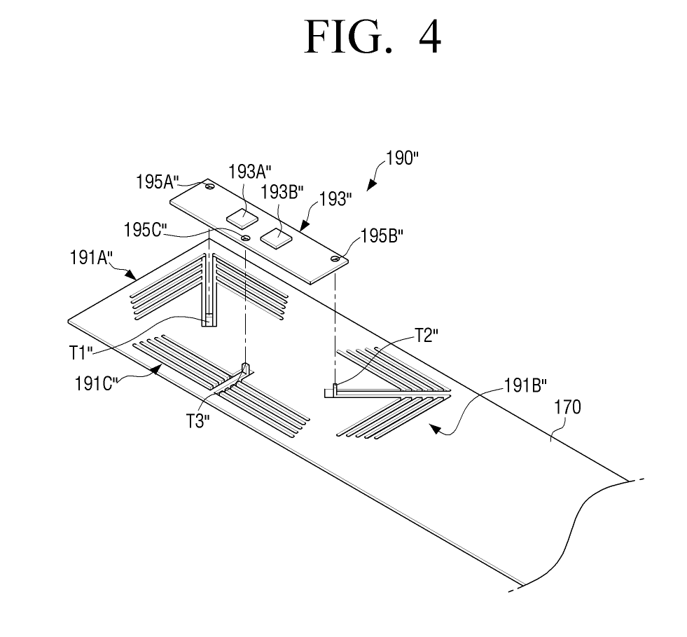

With reference to FIG. 4, in an antenna unit 190″, a plurality of connecting terminals 195A″, 195B″, and 1950″ of a communication module 193″ may be formed as through-holes. In this case, ends of connecting terminals T1″, T2″, and T3″ of first and second radiation patterns 191A″, 191B″, and 1910″ may be bent in the same direction in order to be inserted into the plurality of connecting terminals 195A″, 195B″, and 1950″ of the communication module 193″. In this structure, the connecting terminals T1″, T2″, and T3″ of first and second radiation patterns 191A″, 191B″, and 1910″ are directly soldered to the plurality of connecting terminals 195A″, 195B″, and 1950″ of the communication module 193″ respectively.

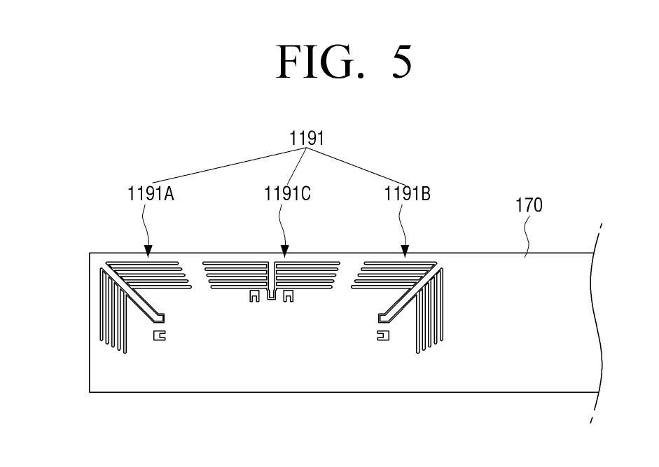

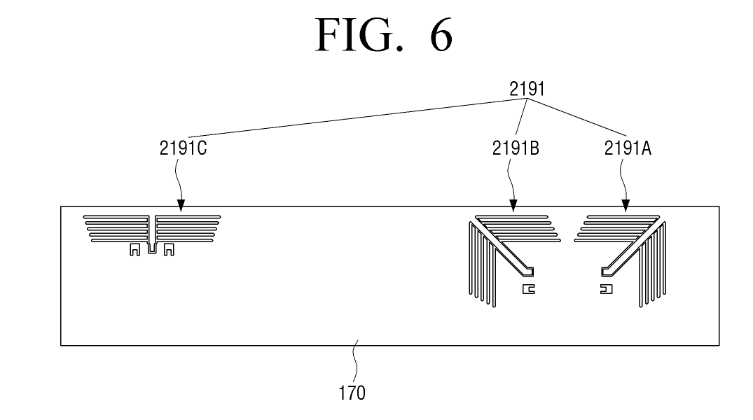

The location of the first radiation patterns 191A and 191B and the second radiation pattern 191C is not limited to that shown in FIG. 2, but may be provided as shown in FIG. 5 or 6. That is, in a slot antenna 1191 shown in FIG. 5, a second radiation pattern 1191C may be located between radiation patterns 1191A and 1191B. In a slot antenna 2191 shown in FIG. 6, radiation patterns 2191A and 2191B may be spaced apart from a second radiation pattern 2191C. In FIGS. 5 and 6, the communication module 193 is not illustrated for convenience of description.

The reason why the radiation patterns 2191A and 2191B are spaced apart from the second radiation pattern 2191C as shown in FIG. 6 is to secure isolation to prevent communication problems caused by signal interference when a Bluetooth signal and a Wi-Fi signal share the same frequency band (for example, 2.4 GHz).

With reference to FIG. 7, the signal transfer apparatus 100A consistent with the second exemplary embodiment has the same construction as the first exemplary embodiment except that the antenna unit 190 is not provided on an external case 170A but on a shield plate 230. In the signal transfer apparatus 100A consistent with the second exemplary embodiment, description of the same construction as the first exemplary embodiment is not repeated.

The external case 170A covers the shield plate 230 entirely. The external case 170A may be made of a nonmetallic material to transmit or receive a signal smoothly without interference using the antenna unit 190 provided on the shield plate 230. In this case, the external case 170A may be made of a synthetic resin material in light of ease of manufacture and strength.

The shield plate 230 may be made of a metallic material to block EMI generated by the controller 150 and diverse electronic units and enhance EMC.

The location of the antenna unit 190 in the second exemplary embodiment changes from the external case 170 in the first exemplary embodiment to the shield plate 230, but the detailed construction of the antenna unit 190 is the same as in the external case 170 of the first exemplary embodiment as shown in FIGS. 2 to 6.

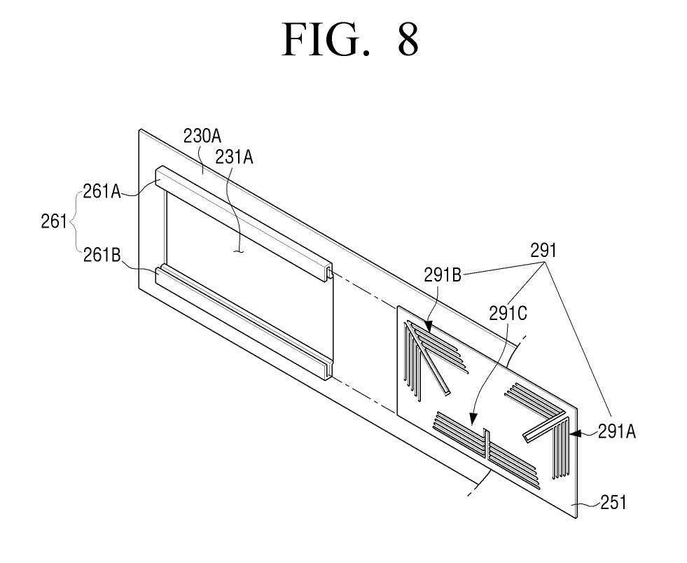

When the antenna unit 190 consistent with the second exemplary embodiment includes the slot antenna 191 and the communication module 193 in one body as in the antenna units 190′ and 190″ shown in FIGS. 3 and 4 of the first exemplary embodiment, the antenna unit 190 may be manufactured as a separate component and be connected to the shield plate 230 as shown in FIGS. 8 to 11. In FIGS. 8 to 11, the communication module is not illustrated for convenience of description.

With reference to FIG. 8, a slot antenna 291 is not perforated directly on a shield plate 230A, but is perforated on a separate conductive metal plate 251. In this case, the slot antenna 291 includes first radiation patterns 291A and 291B to radiate a first antenna signal (for example, a Wi-Fi signal), and a second radiation pattern 291C to radiate a second antenna signal (for example, a Bluetooth signal).

The shield plate 230A includes a first coupling 261 to be coupled to the metal plate 251. The first coupling 261 may include a pair of slots 261A and 261B along sides of an antenna signal radiation hole 231A formed on the shield plate 230A that face each other.

In this case, the pair of slots 261A and 261B may be formed by bending a portion of the shield plate 230A in multi-steps. When the slot antenna 291 is slid into the first coupling 261, the upper side and lower side of the slot antenna 291 may be stably inserted into the pair of slots 261A and 261B. The width of the slots 261A and 261B may be equal to or smaller than the thickness of the metal plate 251 so that the pair of slots 261A and 261B may securely fix the metal plate 251.

In FIG. 8, the first coupling 261 is formed using the portion of the shield plate 230A, but is not limited thereto. It is also possible that the shield plate 230A and a separate member (not shown) are provided in a slot form and are welded together along sides of the antenna signal radiation hole 231A which face each other.

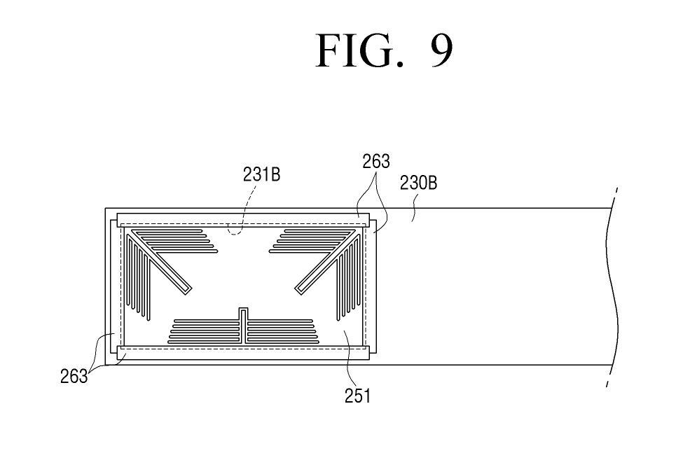

With reference to FIG. 9, a second coupling 263 may include a plurality of conductive adhesive tapes. In order to fix the metal plate 251 using the conductive adhesive tapes, the metal plate 251 is placed on a location corresponding to an antenna signal radiation hole 231B, and is taped on a shield plate 230B along the four sides of the metal plate 251 using the conductive adhesive tapes 263. When the metal plate 251 is fixed on the shield plate 230B using the conductive adhesive tapes 263, it is easy to fix the meal plate 251 without a separate component to fix the metal plate 251.

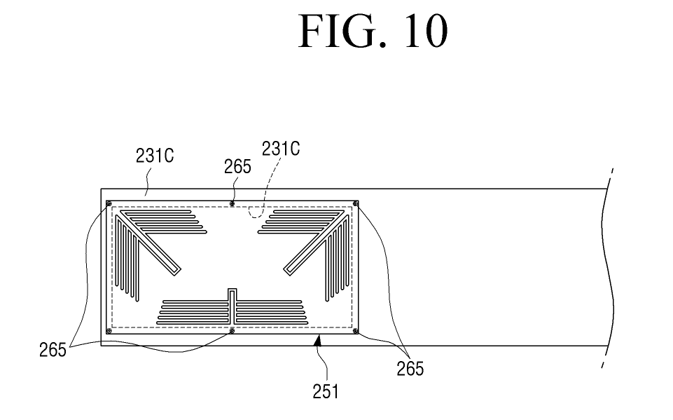

With reference to FIG. 10, a third coupling 265 may include a plurality of screws. In this case, the metal plate 251 is fixed to the shield plate 230C by penetrating and tightening a portion of the four sides of the metal plate 251 and a portion around an antenna signal radiation hole 231C using the screws. When the third coupling 265 is used, the metal plate 251 is easily separate from the shield plate 230C by loosening the screws so that maintenance and repair may become easy.

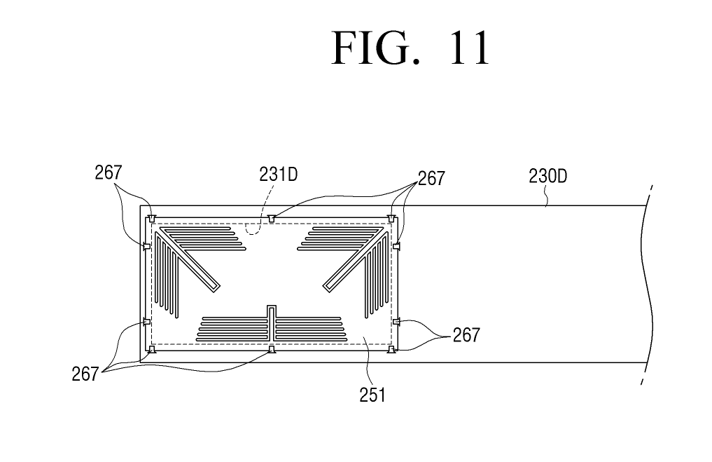

With reference to FIG. 11, a fourth coupling means 267 may include a plurality of fixing protrusions perforated around an antenna signal radiation hole 231D. In this case, the plurality of fixing protrusions may be formed using a portion of the shield plate 230D, and may be located to correspond to the edge of the metal plate 251 in order to fix the edge of the metal plate 251. When the metal plate 251 is fixed to the shield plate 230D using the fourth coupling 267, the portion of the shield plate 230D is used without any separate fixing member so that the manufacture may be simple.

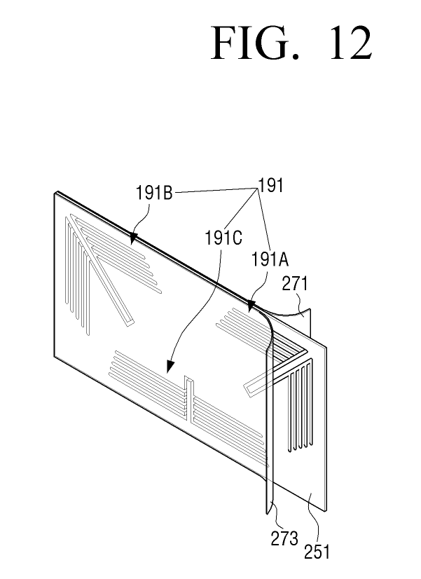

In the metal plate 251 shown in FIGS. 8 to 11, when foreign substances flow into the first and second radiation patterns 291A, 291B, and 291C, the performance of the antenna may deteriorate. Accordingly, in order to prevent performance deterioration of the antenna, foreign substance blocking members 271 and 273 may be attached to both sides of the metal plate 251 as shown in FIG. 12. The foreign substance blocking members 271 and 273 may be insulating tapes or insulating films (for example, a thin plastic film of polypropylene).

When the first and second radiation patterns 191A, 191B, and 191C are directly provided on the shield plate 170 as shown in FIG. 7, the foreign substance blocking members 271 and 273 may be attached to the front side and the rear side of the shield plate 170.

With reference to FIG. 13, the signal transfer apparatus 100B consistent with the third exemplary embodiment may include a housing 110, a plurality of collecting terminal panel (not shown) provided at the rear of the housing 110, a controller 150 installed in the housing 110, an external case 170 to cover the interior of the housing 110, and an antenna unit 190 as in the signal transfer apparatus 100 consistent with the first exemplary embodiment.

In addition, the signal transfer apparatus 100B consistent with the third exemplary embodiment may include a control panel 140 which includes a plurality of manipulation buttons 141 to enable a user to manipulate the signal transfer apparatus 100B, a power button 142, and a display 143 at the front of the housing 110.

The antenna unit 190 in the signal transfer apparatus 100B consistent with the third exemplary embodiment may be formed in a separate type in which the slot antenna 191 and the communication module (not shown) are connected via a plurality of cables as shown in FIG. 2 of the first exemplary embodiment, or may be formed in an combined type in which the slot antenna 191 and the communication module (not shown) are provided in one body as shown in FIGS. 3 and 4 of the first exemplary embodiment. In this case, the construction of the communication module in the signal transfer apparatus 100B consistent with the third exemplary embodiment is the same as that of the communication module 193 in the first exemplary embodiment.

In addition, the slot antenna 191 in the third exemplary embodiment is provided at the external case 170, but is not limited thereto. When the signal transfer apparatus 100B includes a shield plate (not shown) made of a conductive metallic material as in the signal transfer apparatus 100A consistent with the second exemplary embodiment (see FIG. 7), the slot antenna 191 may be provided at the shield plate. When the signal transfer apparatus 100B includes the shield plate, the external case 170 may be made of a nonmetallic material (for example, a synthetic resin material having a predetermined hardness) to prevent signal interference.

In FIG. 13, reference numeral 171 indicates a plurality of heat radiation holes provided at the external case 170 to discharge heat generated in the signal transfer apparatus 100B outside the external case 170.

The foregoing exemplary embodiments and advantages are merely exemplary and are not to be construed as limiting the embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A signal transfer apparatus, comprising:
a housing;
an interface provided at a housing to be connected to an external device to one of transmit a signal to and receive a signal from the external device;
an external case configured to cover the housing;
an antenna unit configured to comprise a slot antenna, and a communication module connected to the slot antenna and one of transmit a signal to and receives a signal from an external wireless device through the slot antenna; and
a controller provided in the housing to be electrically connected to the interface and the antenna unit, and to one of transmit an external signal received through one of the interface and the antenna unit directly to a display apparatus and to convert the external signal and transmit the converted signal to the display apparatus.

2. The signal transfer apparatus as claimed in claim 1, wherein the external case is made of a conductive metallic material, and the slot antenna is formed on the external case.

3. The signal transfer apparatus as claimed in claim 2, wherein the slot antenna comprises at least one radiation pattern which is perforated on the external case.

4. The signal transfer apparatus as claimed in claim 2, wherein a connecting terminal of the communication module is connected to a connecting terminal of the slot antenna via at least one cable.

5. The signal transfer apparatus as claimed in claim 2, wherein a connecting terminal of the communication module is directly soldered to a connecting terminal of the slot antenna.

6. The signal transfer apparatus as claimed in claim 1, further comprising:
a shield plate configured to be made of a conductive metallic material to block an electromagnetic wave and be covered by the external case,
wherein the external case is made of a non-metallic material.

7. The signal transfer apparatus as claimed in claim 6, wherein the slot antenna comprises at least one radiation pattern perforated on the shield plate.

8. The signal transfer apparatus as claimed in claim 7, wherein a connecting terminal of the communication module is connected to a connecting terminal of the slot antenna via at least one cable.

9. The signal transfer apparatus as claimed in claim 7, wherein a connecting terminal of the communication module is directly soldered to a connecting terminal of the slot antenna.

10. The signal transfer apparatus as claimed in claim 6, wherein the shield plate comprises an antenna signal radiation hole through which an antenna signal of the slot antenna passes, and the antenna unit is provided at a location corresponding to the antenna signal radiation hole.

11. The signal transfer apparatus as claimed in claim 10, wherein the antenna unit comprises a conductive metal plate on which at least one radiation pattern of the slot antenna is perforated.

12. The signal transfer apparatus as claimed in claim 11, further comprising:
a coupling configured to separably couple the metal plate to the shield plate.

13. The signal transfer apparatus as claimed in claim 12, wherein the coupling is a pair of slots extended in parallel along sides of the antenna signal radiation hole which slots face each other.

14. The signal transfer apparatus as claimed in claim 12, wherein the coupling is a conductive adhesive tape to attach the metal plate to the shield plate.

15. The signal transfer apparatus as claimed in claim 12, wherein the coupling is a plurality of connecting members to fix the metal plate to the shield plate.

16. The signal transfer apparatus as claimed in claim 12, wherein the coupling is a plurality of fixing protrusions extended from the shield plate and formed around the antenna signal radiation hole.

17. The signal transfer apparatus as claimed in claim 1, wherein a connecting terminal of the communication module is directly soldered to a connecting terminal of the slot antenna.

18. The signal transfer apparatus as claimed in claim 11, wherein the metal plate is attached with at least one foreign substance blocking member to prevent a foreign substance from flowing into the radiation pattern.

19. The signal transfer apparatus as claimed in claim 18, wherein the foreign substance blocking member is an insulating tape or an insulating film.

20. The signal transfer apparatus as claimed in claim 1, wherein the communication module comprises a first communication circuit and a second communication circuit to one of transmit and receive at least two different signals respectively, and the slot antenna comprises at least one first radiation pattern to be connected to the first communication circuit, and at least one second radiation pattern to be connected to the second communication circuit.
